(19) United States
(12) Patent Application Publication
(10) Pub. No.: US 2005/0057576 A1
(43) Pub. Date: Mar. 17, 2005

(54) Geometric space decoration in graphical design system

(75) Inventors: Jianbin Shen, Carlingford (AU); Gerard Anthony Hill, Castle Hill (AU); Lincoln David Stone, Townsville (AU); Colin Eric Druitt, Marsfield (AU)

Correspondence Address: FITZPATRICK CELLA HARPER & SCINTO, 30 ROCKEFELLER PLAZA, NEW YORK, NY, 10112, US

(73) Assignee: Canon Infor. Systems Research Australia Pty. Ltd., New South Wales (AU)

(21) Appl. No.: 10/865,255

(22) Filed: Jun. 10, 2004

(30) Foreign Application Priority Data
Jun. 12, 2003 (AU) 2003902954

(51) Int. Cl. G09G 5/00

(52) U.S. Cl. 345/619; 345/649; 345/689; 345/604; 345/108

(57) ABSTRACT

Disclosed is a graphical representation (602) formed of at least one template having a plurality of graphical objects arranged in a predetermined number of rendering layers (702, 703, 706, 707) spanning a geometric space. At least one of the layers (702, 703) has user-alterable parameters and incorporates at least one multiply instantiated user-definable graphical object (204) distributed upon the at least one layer according to application of the parameters to a plurality of presentation rules. A method for forming such a graphical representation from a template is also disclosed. The method includes accessing at least one user-manipulable effect definition (129) associated with one of the rendering layers (109). The effect definition has parameter information defining characteristics of the one layer. The parameter information of the effect definition is modified (111) to thereby incorporate a multiply instantiated user-definable graphical object distributed across the one layer according to a plurality of presentation rules. A script of a graphical design formed by the layers is then generated (120) and rendered (121) into a viewing memory image (123). The memory image is output to a display (124) device to thereby reproduce the graphical representation.

### CROSS-REFERENCE TO RELATED APPLICATION

This application claims the right of priority under 35 U.S.C. § 119 based on Australian Application No. 2003902954, filed Jun. 12, 2003, which is incorporated by reference herein in its entirety as if fully set forth herein.

### COPYRIGHT NOTICE

This specification contains material that is subject to copyright protection. The copyright owner has no objection to the reproduction of this specification or related materials from associated office files for the purposes of review, but otherwise reserves all copyright whatsoever.

### FIELD OF THE INVENTION

The present invention relates generally to graphical image generation and, in particular, to a graphical design system based upon templates and rules. The present invention also relates to a method and apparatus for graphical design, and to a computer program product including a computer readable medium having recorded thereon a computer program for graphical design.

### BACKGROUND

Many computer-implemented products presently on the market allow a user to create an artistic presentation. These products are usually categorised into two groups, those being advanced artistic design tools and simple presentive design tools. The former allows the user to design a sophisticated graphical appearance. However, this kind of tool requires that the user have reasonable knowledge of graphic design and extensive experience with the tools. People who use this kind of tool are typically professional artists, for example, web designers who design a graphic interface for delivery to an end user, who typically accesses the interface via a browser application operating over the

### CROSS-REFERENCE TO RELATED APPLICATIONS

This application claims the right of priority under 35 U.S.C. § 119 based on Australian Application No. 2003902954, filed Jun. 12, 2003, which is incorporated by reference herein in its entirety as if fully set forth herein.

### COPYRIGHT NOTICE

This specification contains material that is subject to copyright protection. The copyright owner has no objection to the reproduction of this specification or related materials from associated office files for the purposes of review, but otherwise reserves all copyright whatsoever.

### FIELD OF THE INVENTION

The present invention relates generally to graphical image generation and, in particular, to a graphical design system based upon templates and rules. The present invention also relates to a method and apparatus for graphical design, and to a computer program product including a computer readable medium having recorded thereon a computer program for graphical design.

### BACKGROUND

Many computer-implemented products presently on the market allow a user to create an artistic presentation. These products are usually categorised into two groups, those being advanced artistic design tools and simple presentive design tools. The former allows the user to design a sophisticated graphical appearance. However, this kind of tool requires that the user have reasonable knowledge of graphic design and extensive experience with the tools. People who use this kind of tool are typically professional artists, for example, web designers who design a graphic interface for delivery to an end user, who typically accesses the interface via a browser application operating over the World Wide Web. The end user in such an instance is not in a position to make the changes to the graphical design when such is delivered.

On the other hand, the second category of product is a simple presentive design tool that targets the inexperienced user to create simple presentations. This kind of product usually provides a set of the simple presentation templates. The user can modify or contribute to the template with simple items, for example, by typing in text in a text block forming part of the template. The disadvantage of this kind of tool is the lack of an ability to develop advanced graphics commonly found in the formerly described products.

### SUMMARY

It is an object of the present invention to substantially overcome, or at least ameliorate, one or more disadvantages of existing arrangements through provision of a system that balances the needs of the advanced graphical designers and simple users.

According to a first aspect of the present disclosure, there is provided a graphical representation formed of at least one template having a plurality of graphical objects arranged in a predetermined number of rendering layers spanning a geometric space, at least one of said layers having user-alterable parameters and incorporating at least one multiply instantiated user-definable graphical object distributed upon said at least one layer according to application of said parameters to a plurality of presentation rules.

According to a second aspect of the present disclosure, there is provided a method for forming a graphical representation from a template having a plurality of graphical objects arranged in a predetermined number of rendering layers spanning a geometric space, said method comprising the steps of:
(a) accessing at least one user-manipulable effect definition associated with one of said rendering layers, said effect definition including parameter information defining characteristics of said one layer;
(b) modifying the parameter information of said effect definition to thereby incorporate a multiply instantiated user-definable graphical object distributed across said one layer according to a plurality of presentation rules;
(c) generating a script of a graphical design formed by said layers;
(d) rendering the script into a viewing memory image;
(e) outputting the memory image to a display device to thereby reproduce said graphical representation.

According to a third aspect of the present disclosure, there is provided a method of decorating a geometric space, said method comprising the steps of:
(a) accessing a target item;
(b) accessing an artwork template associated with said target item and having at least one of a predetermined plurality of rendering layers spanning said geometric space;
(c) assigning said target item to one said artwork template corresponding to a fixed one of said layers;
(d) accessing decorative effect information of said artwork template corresponding to a user-manipulable one of said layers, said template having user-alterable parameters;
(e) manipulating said user-alterable parameters to provide at least one multiply instantiated user-definable graphical object distributed within said one manipulable layer according to application of said parameters to a plurality of presentation rules;
(f) generating and assembling a renderable script from descriptions of said layers;
(g) rendering and displaying said script to reveal said decorated space.

According to another aspect of the present disclosure, there is provided an apparatus for implementing any one of the aforementioned methods.

According to another aspect of the present disclosure there is provided a computer program product including a computer readable medium having recorded thereon a computer program for implementing any one of the methods described above.

Other aspects of the invention are also disclosed.

### BRIEF DESCRIPTION OF THE DRAWINGS

One or more embodiments of the present invention will now be described with reference to the drawings and appendices, in which:

FIGS. 1(a) and 1(b) show a flowchart depicting operation of an artwork system according to the present disclosure;

FIG. 2 illustrates a preferred graphical user interface for artwork selection;

FIG. 3 illustrates a preferred graphical user interface for decorative operations;

FIG. 4 illustrates a preferred graphical user interface for clipart decorative object selection;

FIG. 5 illustrates a preferred graphical user interface for custom image decorative object selection;

FIG. 6 illustrates a preferred graphical user interface for active viewing of the selected decorative object;

FIG. 7 schematically illustrates effect layers used in the present disclosure;

FIG. 8 shows the task modular diagram depiction operation of the system of the present disclosure;

FIG. 9 is a schematic block diagram of a general purpose computer upon which the system described can be practiced;

FIG. 10 depicts an initial virtual relationships between processes of the artwork system;

FIG. 11 depicts the interactive virtual relationships between processes of the artwork system of FIGS. 1(a) and 1(b);

FIG. 12 is an example of a background of a page (ie. a target item) decorated with the artwork of Appendix A and the decorative effect file of Appendix C;

FIG. 13 shows a further view of the graphical user interface of FIG. 3 showing a dropdown menu;

FIG. 14A is an example of a memory album data tree;

FIGS. 14B to 14I show an example of the GUI development of a photo album page using the system 100;

Appendix A is an example of an artwork file containing decorative effect reference information;

Appendix B is an example a very simple sample of a script document; and

Appendix C is an example of a decorative effect file which is referenced by the artwork file of Appendix A; and

Appendix D is an example of an album file.

### DETAILED DESCRIPTION INCLUDING BEST MODE

1.0 Overview and Hardware Configuration

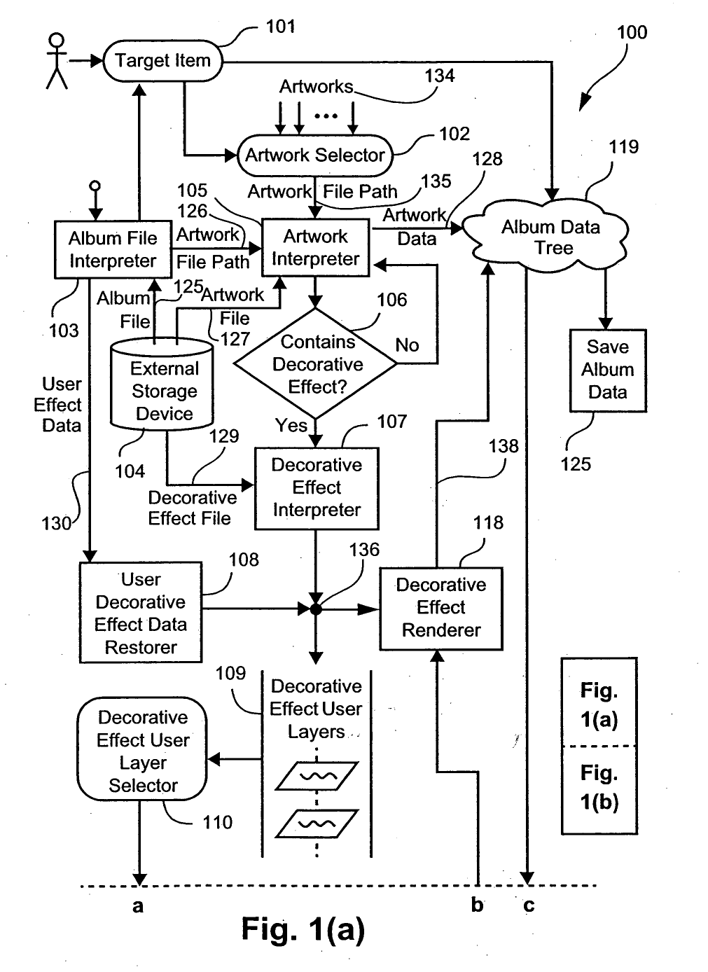

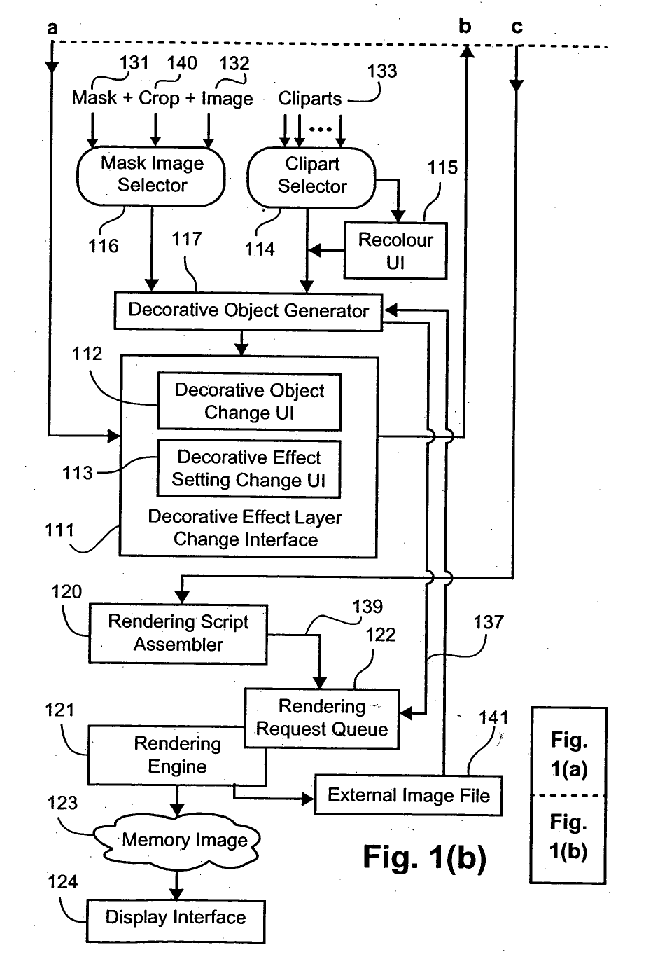

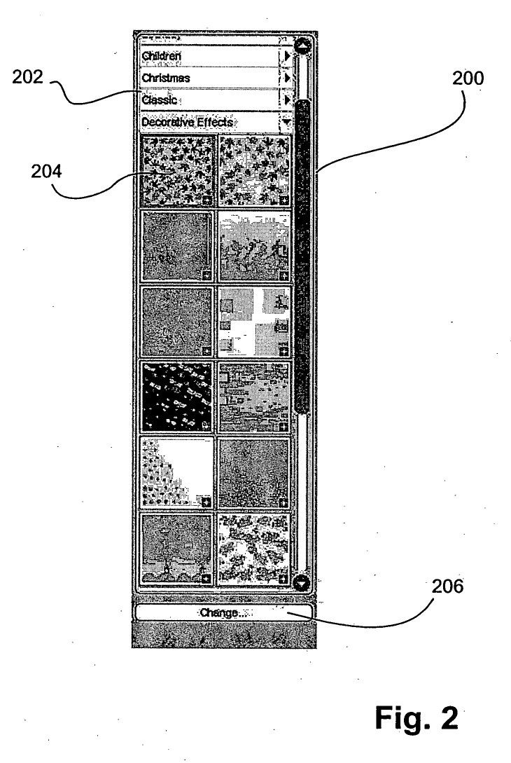

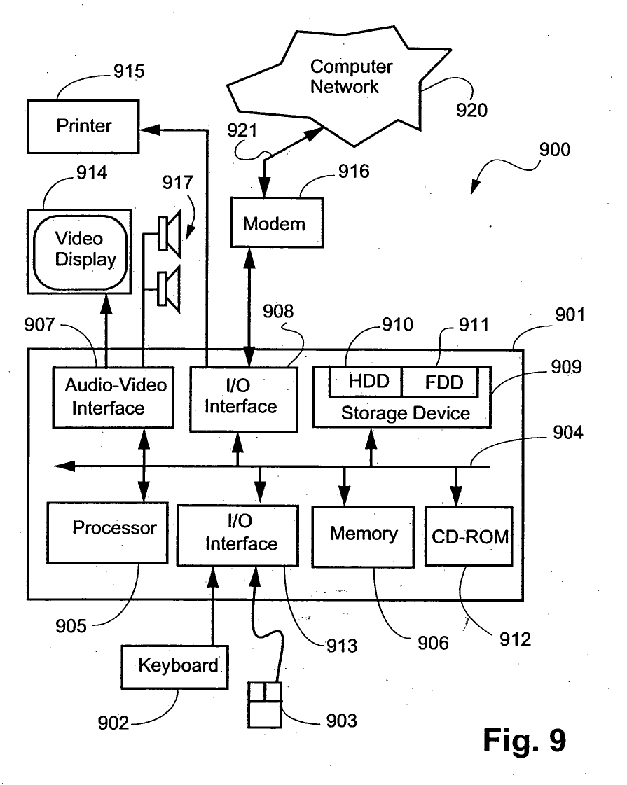

The method of graphical design to be described is preferably practiced using a general-purpose computer system 900, such as that shown in FIG. 9, wherein the processes of FIGS. 1 to 8 may be implemented as software, such as one or more application programs executing within the computer system 900. In particular, the methods of FIGS. 1 to 8 are effected by instructions in the software that are carried out by the computer. The instructions may be formed as one or more code modules, each for performing one or more particular tasks. The software may also be divided into two separate parts, in which a first part performs the graphical design methods and a second part manages a user interface (UI) between the first part and the user, for example via the graphical user interfaces (GUIs) of FIGS. 2 to 6. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for graphical design.

The computer system 900 is formed by a computer module 901, input devices such as a keyboard 902 and mouse 903, output devices including a printer 915, a display device 914 and loudspeakers 917. A Modulator-Demodulator (Modem) or network transceiver device 916 is used by the computer module 901 for communicating to and from a communications network 920, for example connectable via a telephone line 921 or other functional medium. The modem 916 can be used to obtain access to the Internet, and other network systems, such as a Local Area Network (LAN) or a Wide Area Network (WAN), and may be incorporated into the computer module 901 in some implementations.

The computer module 901 typically includes at least one processor unit 905, and a memory unit 906, for example formed from semiconductor random access memory (RAM) and read only memory (ROM). The module 901 also includes a number of input/output (I/O) interfaces including an audio-video interface 907 that couples to the video display 914 and loudspeakers 917, an I/O interface 913 for the keyboard 902 and mouse 903 and optionally a joystick (not illustrated), and an interface 908 for the modem 916 and printer 915. In some implementations, the modem 916 may be incorporated within the computer module 901, for example within the interface 908. A storage device 909 is provided and typically includes at least one hard disk drive 910 and a floppy disk drive 911. A magnetic tape drive (not illustrated) may also be used. A CD-ROM drive 912 is typically provided as a non-volatile source of data. The components 905 to 913 of the computer module 901, typically communicate via an interconnected bus 904 and in a manner which results in a conventional mode of operation of the computer system 900 known to those in the relevant art. Examples of computers on which the described system can be practised include IBM-PC's and compatibles, Sun Sparcstations or alike computer systems evolved therefrom.

Typically, the application program is resident on the hard disk drive 910 and read and controlled in its execution by the processor 905. Intermediate storage of the program and any data fetched from the network 920 may be accomplished using the semiconductor memory 906, possibly in concert with the hard disk drive 910. In some instances, the application program may be supplied to the user encoded on a CD-ROM or floppy disk and read via the corresponding drive 912 or 911, or alternatively may be read by the user from the network 920 via the modem device 916. Still further, the software can also be loaded into the computer system 900 from other computer readable media. The term “computer readable medium” as used herein refers to any storage or transmission medium that participates in providing instructions and/or data to the computer system 900 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 901. Examples of transmission media include radio or infra-red transmission channels as well as a network connection to another computer or networked device, and the Internet or Intranets including e-mail transmissions and information recorded on Websites and the like.

The described methods of graphical design may alternatively or additionally be implemented in dedicated hardware such as one or more integrated circuits performing the functions or sub functions of graphical design. Such dedicated hardware may include graphic processors, digital signal processors, or one or more microprocessors and associated memories.

2.0 Terminology

Before describing the graphical design system of the present disclosure, it is appropriate to clarify a number of terms to be used:

Album: An album is a file saved onto the storage device by the user. An album is preferably formed by a hierarchical data structure that describes the user's changes (inputs) into the designated system. Using such a structure, the system can restore these user's inputs when it restarts. Use of the terms album and album file may be interchanged. An example of an album file is provided in Appendix D.

Album Data Tree: A hierarchical memory data structure that represents the changes the user makes through the system. The tree data includes target items, item-associated artwork data and decorative effect data changed by the user. The tree may also be constructed from an album file, upon which the changes can be made.

Artwork File: An artwork comprises of a collection of the structural data that defines a combination of geometric objects (eg. shapes or outlines) and various attributes (eg. the fill colours) of those objects and/or the collection. These various geometric objects may serve different purposes. For example, a square geometric object may be used as a graphical boundary. On the other hand, a group of geometric objects may construct, say, the living objects, such as flowers and animals. A color attribute may be used to define a color characteristics of the objects, for example, a yellow flower and a blue square. Artwork may also contain a set of optional colors for a geometric object. This provides the functionality for creating an object with various versions of colours without replicating the same artwork data structure. Artwork may also define a pattern of geometric objects, for example, replicating of circles. Beyond geometric shapes and colours, artwork may define data for more sophisticated purposes. For example, an artwork may be used as a frame for a display object, such as a photo or the text. It may be used to define a space, for example, a background. Artwork may be saved as an external media object (eg. a file) on any storage device and may be opened for (re)use at a later stage. Certain arrangements of artwork may be used to define standard or predetermined templates.

Clipart: A clipart is an artwork, specially used to define foreground art object(s) as remnants.

Decorative Artwork: Decorative artwork is artwork that contains geometric objects (usually shapes) and which is associated with a decorative effect by way of a file path of a decorative effect file being an attribute of the artwork, and each of the geometric objects containing a flag indicating that the object has the decorative effect applied to it. Appendix A shows a sample of a decorative artwork file.

Decorative Effect: Synonymous with Particle Effect (see below) used in the context of the hosting software.

Decorative Effect File: A decorative effect file incorporates a collection of the hierarchical data structure that defines the decorative effect characteristics (attributes) with which effect rules are applied to a given geometric space. Appendix C shows a sample of a decorative effect file.

Decorative (Graphical) Object: A visual image object used in the decorative effect.

Decorative Space: A geometric space in which decorative graphical objects are laid out based on the rules which govern the relationship between the decorative objects in the space as well as the relationship between the decorative objects and a boundary of the space.

Geometric (Boundary) Space: A geometric outline (or shape).

Effect Library (EL): A library of various visual effects applicable to graphical objects. Examples of such effects include the particle effect, the image effect, the ripple effect, the transform effect, the fill effect and the knotwork effect. Such effects may be generated according to the principles disclosed in the following published specifications:
(i) Australian No. 728,961 corresponding in disclosure to U.S. application Ser. No. 09/153,077, entitled “A Font Architecture and Creation Tool for Producing Richer Text”;
(ii) Australian No. 730,473 corresponding in disclosure to U.S. Pat. No. 6,504,545, entitled “A Method of Animating Computer Typefaces”;
(iii) Australian No. 742,546 corresponding in disclosure to U.S. application Ser. No. 09/384,432, entitled “A Method and Apparatus for Parametric Variation of Text”;
(iv) Australian Publication No. AU-A-57994/01, entitled “Method and Apparatus for Constrained Osculatory Packing”; and
(v) Australian No. 714,685, corresponding to United States No. 6,542,157, entitled “Font Decoration By Automatic Mesh Fitting”;
The effect libraries achieve a graphical decoration on a given boundary space. Each effect consists of an effect engine and associated data classes and data files. Each decorative effect data file contains a collection of the structural parameter data that defines decorative characteristics with which effect rules are applied to the geometric space. The data classes are the memory representation of the data file in the computer. The effect engine generates the descriptive scripts of the graphical decoration on the given geometric space from the defined rules supplied with the data. These effects may be used individually, but may also be used together to achieve a combined overall effect.

Particle Effect: One of the effects preferably contained in the effects library referred to above and described in the referenced publications. Particle effect defines various rules to distribute graphical images in and/or onto the boundary space with constraint data, for example, a size constraint.

Template: A template is a set of one or more pre-defined structural data files, generally including an artwork file and a referenced decorative effect file. Initially, specialist artists design the templates to make the best design from the artistic perspective. These artist-designed templates are then able to be readily modified by the end user through a system user interface, to thereby meet the user's own preferable design in the designated system. Although a template is described with reference to multiple files, the template can also be a single file.

Target Item: A target item is an object to which the associated type of artwork is applied. A target item may be a page, a photo and a text string. Thus, there may be different types of artworks for the different types of the target items. That is, there can be background artworks for page item type, the photo frame artworks for the image photo item type and the text frame artworks for the text string.

3.0 Decorative Artwork System

FIG. 1 shows a processing and dataflow implementation of a decorative artwork system 100 as such appears in relation to a hosting application process, such as an application program executing under an operating system upon the general-purpose computer 900 in the fashion described above. A exemplary application of the system 100 is for the generation of artwork associated with an electronic photo album being compiled by a user from a collection of images, such as digital photographs. Essentially the purpose of such an application is to enable placement onto a printable page of one or more images, typically bordered by artwork that aesthetically frames the images and/or pages. Such, where desired and so applied, may be used to define a theme to across certain pages the album.

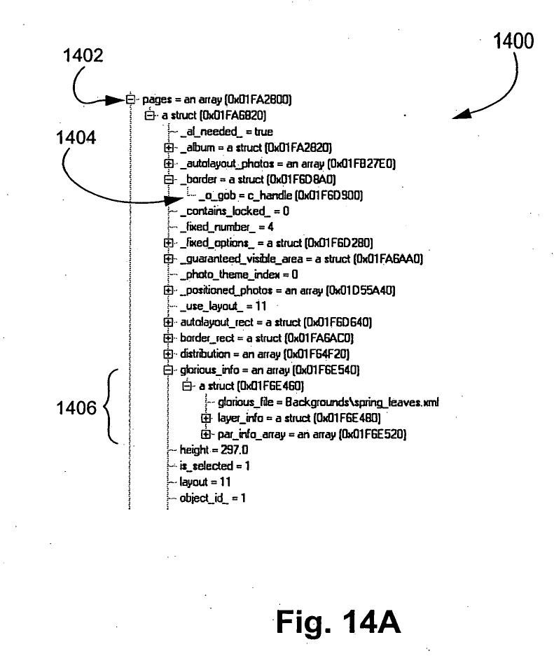

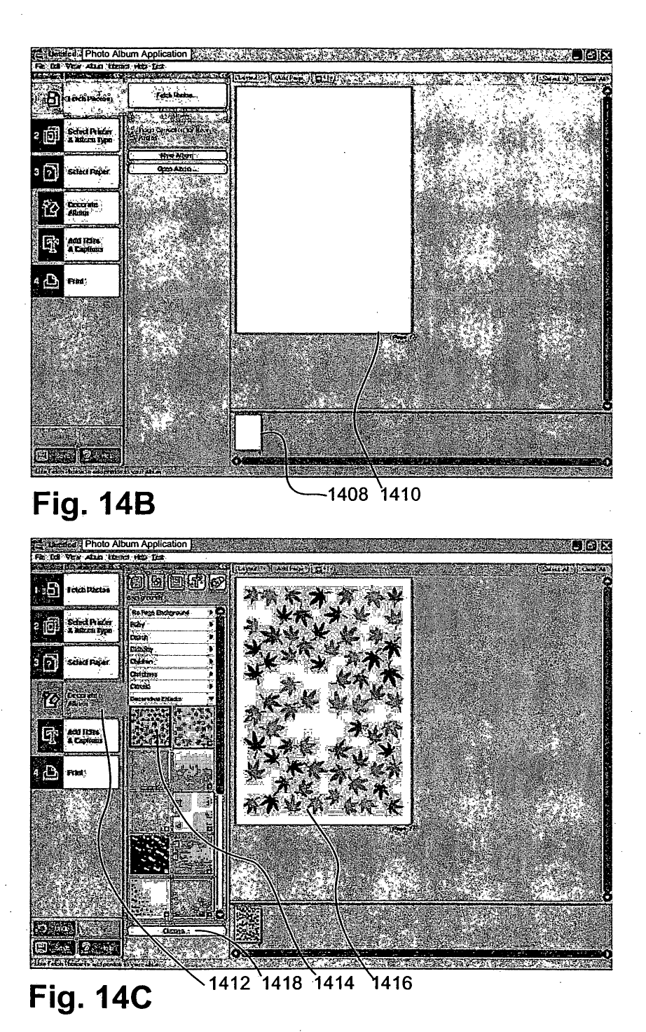

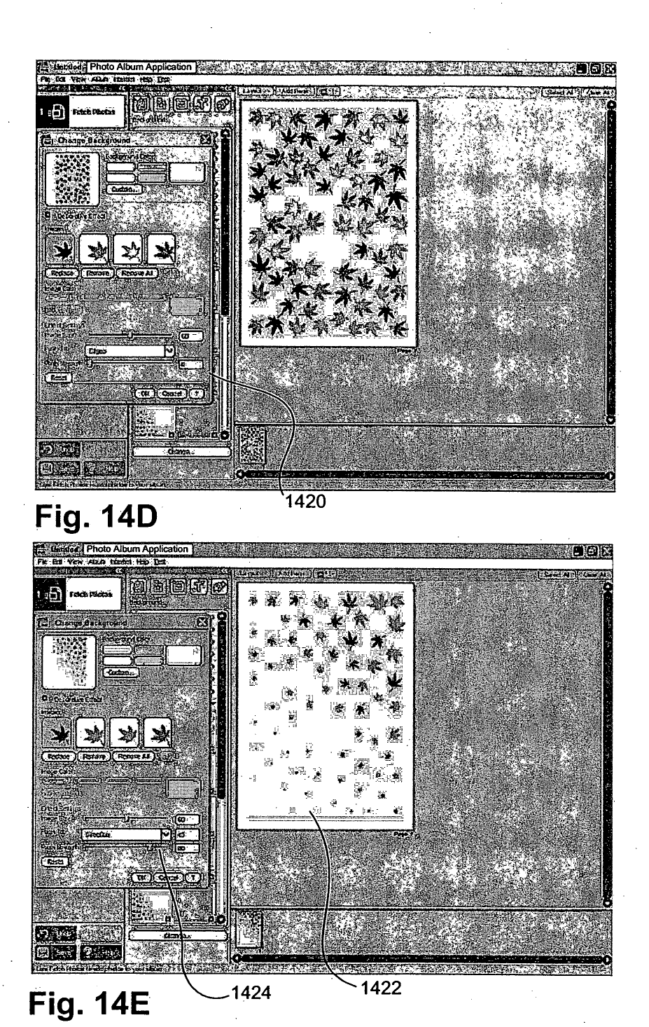

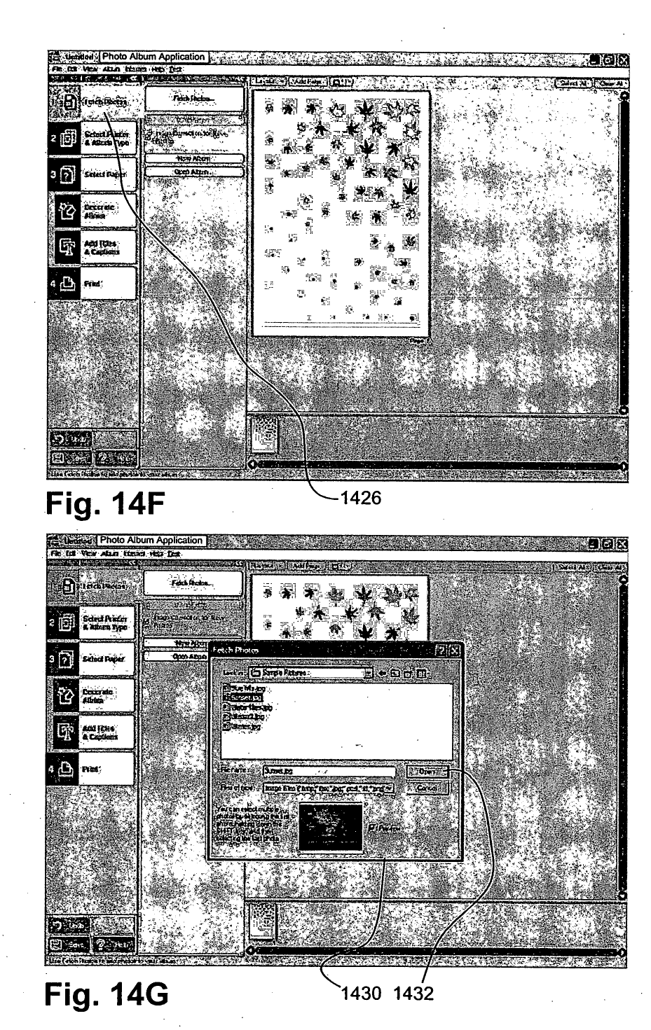

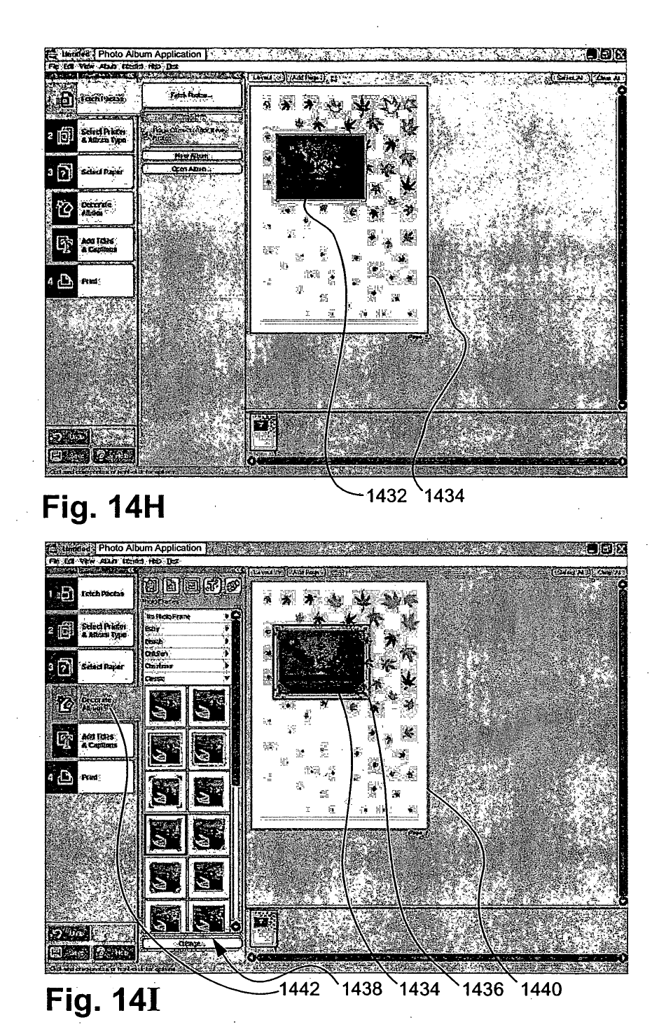

The user can start the design from scratch or by restoring an album file the user has previously saved. In the case of starting the design by restoring an album file, the user may select a saved album file 125 from the external storage device 104 through the hosting system. Such a device 104 may be the HDD 910 of the computer system 900. The selected album file 125 is passed to an album file interpreter 103. The interpreter 103 loads and parses the album. The interpreter 103 restores target items 101 recorded in the album file 125, and invokes an artwork interpreter 105 to restore artwork data 128. The album file interpreter 103 also restores previously generated user decorative effect data 130 by a user effect data restorer 108, thereby making such data 130 subsequently available through the rest of the system 100, as will be described in detail later. An album data tree 119 is then constructed using the artwork data 128, the target item 101, and decorative effect data 138 (to be described). The tree 119 forms a hierarchical representation of all data to be used to construct the album. An example 1400 of such a tree is shown in FIG. 14A. A page item 1402 is the node of the tree 1400 and which also includes reference to artwork graphical object (gob) data 1404, and decorative delta data 1406.

In case of starting the design from the scratch, the user may select a target item 101 in the hosting system. In the photo album example above, the target item could be the digital photographic image to be placed on the page. The system 100 adds the target item into the album data tree 119. An artwork from a list 134 of artwork files is then able to be selected by the user for the selected target item 101 by the user manipulating a user interface illustrated as an artwork selector 102. The artwork files are typically stored in the external storage device 104. A path 135 of a selected artwork file 127 is passed to the artwork interpreter 105 from the artwork selector 102. The interpreter 105 loads the artwork file 127 from the external storage device 104, and parses the file 127 into its memory representative data structure 128 and adds the data structure 128 into the album data tree 119 associated with the target item 101. The selected artwork file 127 may have some geometric objects associated with a decorative effect. Thus, the interpreter 105 is associated with a check 106 to determine if the artwork file 127 contains such decorative effect information. Different geometric objects may be associated with different decorative effects.

Upon the detection of the decorative effect information in the artwork, a decorative effect interpreter 107 is invoked and is provided with the detected decorative effect information. The interpreter 107 loads a corresponding decorative effect file 129 from the external storage device 104 and parses the file 129 into its memory representative data structure 136. In the case that the process was starting from a loaded album file 125 as described above, the data 136 may be overwritten by user decorative effect data (delta values) restored from the album file 125 through the user effect data 130 and a user decorative effect data restorer 108. The decorative effect data structure 136 is organised in a layer-based fashion as a number of decorative effect layers 109, including one or more user layers and one or more fixed layers.

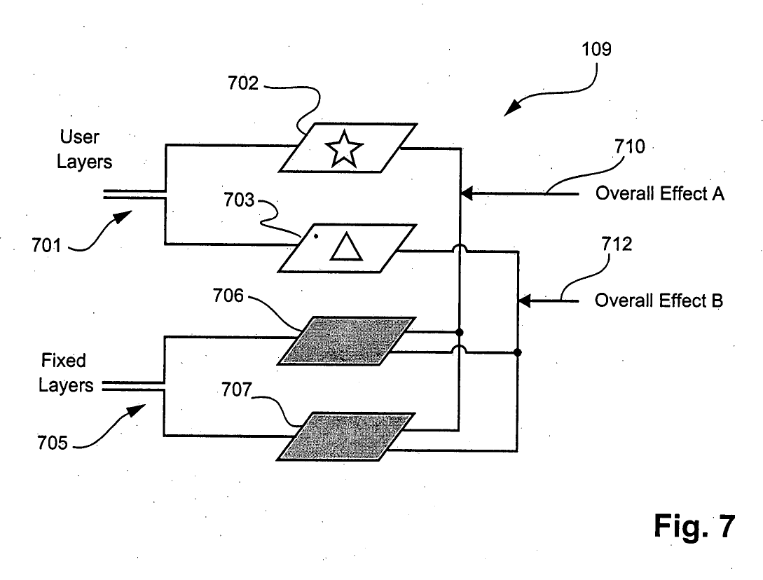

An overall effect is constructed by the user layer(s) combining with all fixed layer(s). FIG. 7 shows a sample illustration of the effect layer mechanism. A number of user layers 701 are provided that include layers 702, 703 that the system 100 allows the user to manipulate, by exposing decorative parameters through a user interface so that the user is able to create a personalized design out of the decorative effect file 129. On the other hand, a number of fixed layers 705 are provided. These are seen as pre-determined layers 706, 707 that an artist may provide in the same decorative effect file to enhance the overall effect and which is not intended for the user to change. The content of the layers 706, 707 may comprise any graphical image and such becomes a foundation for the user layers 701 which are usually rendered above the layers 705. The system 100 as such does not expose parameters of the fixed layers 705 to the user for change. Further, the user layers 701 may also be provided with a transparency parameter thereby enabling the user to define the level of opacity of the corresponding layer, or graphical objects in the layer, and therefore the extent to which the fixed layers 705 are visible beneath the overlying user-definable objects.

Returning to FIG. 1, a decorative effect layer selector 110 provides the user with an interface to select, at any one time, one of the user layers 701, for editing. The user can thus manipulate the exposed information of the selected layer through a decorative effect layer change interface 111. Further, at the time of passing the decorative effect data 136 to the layer selector 110, the data 136 is also passed to the decorative effect renderer 118 so that the user is able to view the existing effect design progressively through the rest of the process. The renderer 118 in this regard is coupled via the user interface through the rest of the system to display the design to the user upon the video display 914.

From the decorative effect layer selector 110, the decorative effect layer change interface 111 is shown to the user. The interface 111 exposes a set of the decorative effect information to the user. The user can modify the set of information. This, in turn, controls the decorative effect design, such as the graphical objects and the graphical pattern. The information presented to the user is organised in a meaningful and sensible way so that the user can understand and customise the decorative effect design easily. The interface presents two groups of information—a group of the graphical decorative objects and a corresponding manipulation interface shown as decorative object change user interface 112, and a group of the decorative design pattern controls shown as decorative effect setting change user interface 113.

The decorative objects are those objects that decorate a geometric space. The selectable decorative effect user layers 702, 703 pre-define a set of the decorative objects. However, the user can add and replace the decorative objects by using clipart 133 and/or the custom images 132, both of which are typically stored in the external storage devices 104. A clipart selector 114 is provided as a user interface that allows the user to select a clipart 133 from a list or repository of cliparts. The selected clipart may be re-coloured with the recolour user interface 115 so that the user can choose a preferred colour for the decorative object to be constructed from the selected clipart. As seen in FIG. 7, the user layers 702 and 703 respectively include clipart in the form of a star and a triangle.

A mask image selector 116 forms a user interface that allows the user to construct a decorative object from a custom image 132. The selector 116 also gives the user the ability to crop 140 and frame the custom image 132 using a predefined mask 131, which may be selected from a set of such masks. The selection from the interfaces 114, 115 and 116 passes the information to a decorative object generator 117. The generator creates a rendering script 137, out of the information and then adds the script 137 to a rendering request queue 122. The rendering request queue 122 gives the system 100 the ability to render the script 137 in an asynchronous fashion. In this regard, a rendering engine 121 and its queue 122 preferably run in a separate thread from the GUI thread, so that the task being performed does not block or impede the users freedom to edit, and the various tasks being performed don't block each other. The rendering engine 121 may render to various outputs, such as a memory image and external image file, depending on how the script specifies the output device.

The rendering engine 121 in this instance renders the script 137 into a decorative object image file 141 onto the external storage device 104 whilst the file path is also passed to the decorative object generator 117. The task 117 then passes the image file to the decorative object change user interface 112 where it is displayed to the user and which sets the image file to replace the image slot of the decorative data structure 136 and also triggers a change event.

The decorative effect setting change interface 113 exposes the selected decorative effect layer pattern setting parameters to the user through various graphical controls. Manipulating these controls, the user can change the setting values to the memory decorative effect data structure, thereby triggering a further change event. The setting value parameters are derived from the effects library described above.

A change event arising from the decorative effect layer change interface 111 is applied to the decorative effect data structure 136 as described above. The changes are then extracted from the data structure as decorative delta data and added into the album data tree 119 so that these changes can be saved and restored later on. Meanwhile, the decorative effect data structure is passed onto the decorative effect renderer 118 whenever any change occurs. The renderer 118 creates a script document 138 that describes the decorative effect on the geometric objects of the decorative artwork. This script 138 is then added into the album data tree 119. Appendix B shows an example of a script document for a simple page.

A script assembler 120, iterates through the album data tree 119, including both the rendering script 138, artwork data 128 and the target item 101, and generates rendering script segments, of various data structures in the tree 119 and then assembles them together into a rendering script document 139.

The assembler 120 adds the script document 139 to the rendering request queue 122. The rendering engine 121 then executes the rendering requests one by one through the queue 122. When the engine 121 eventually renders the assembled script into the memory image 123, the memory image 123 is displayed by the hosting system by passing onto the display interface 124 for reproduction upon the display device 914. The album data tree 119 may be saved 125 into the external storage device 104 for reuse at a later time.

FIG. 2 illustrates an example user interface 200 associated with the artwork selector 102. The selection interface 200 presents via the display device 914 a list 202 of the pre-designed artworks to the user. Each decorative artwork has one or more representative graphical image(s) 204. Each representative image of the decorative artwork represents an overall effect of a selectable decorative user layer and all fixed layers of the decorative effect. The image gives the user a visual cue of the decorative artwork. The user may select a decorative layer of the decorative effect by moving the mouse 903 and clicking its representative image. The selection gives a detailed sample of that which can be subsequently manipulated via the decorative effect layer selector 110. From FIG. 2 the user selects the artwork as well as the decorative effect layer. Each image represents a decorative artwork with a particular user layer from which an overall effect is derived. FIG. 2 also shows a change button 206, also selectable using the mouse 903, to allow the user to activate the decorative effect layer change interface 111 to manipulate the form of the selected user layer of the decorative effect of the artwork.

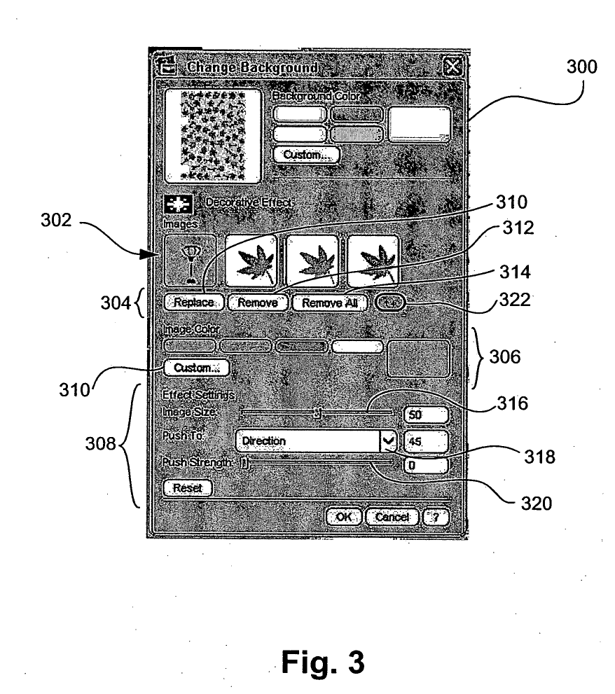

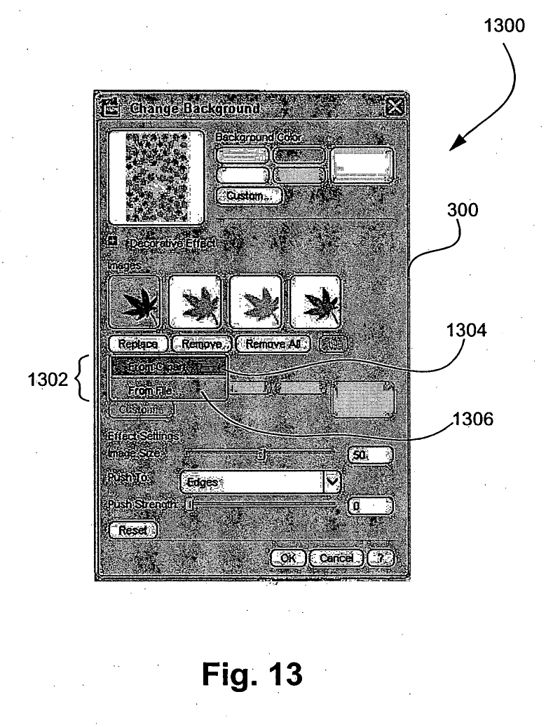

FIG. 3 shows an example of the user interface 300 associated with the decorative effect layer change interface 111. A decorative object representatives group 302 and associated manipulators 304 function as the decorative object change user interface 112. Each decorative object is represented by a graphical image “button” selectable via the mouse 903 in the interface 300. For example, a flower image may represent a flower decorative object. The graphical “button” on which the image is shown gives the user the ability to select the decorative object so that the user can select any of the decorative objects by simply clicking the representative button. Besides the selection of the decorative object, the object manipulators 304 include replacement 310, deletion 312, deletion of all decorative objects 314 and rotation 322. These manipulators 304 are also graphical buttons. The replacement button 310 allows the user to replace any of the decorative objects from different sources. There are two types of sources the user can use to add or replace the decorative objects, including the cliparts 133 and the custom images 132. The clipart 133 is a special kind of artwork to construct a decorative object. Upon the user clicking the replacement button 310, the interface 300 alters to the form 1300 shown in FIG. 13 where a pop-up menu 1302 is presented to the user. The menu 1302 preferably contains two items 1304 and 1306 in rows. The first row item 1304 informs that the user is able to choose a decorative object from a list of clip-arts 133, and the second row item 1306 informs the user of a choice of decorative objects from the user's own file images 132. Clicking on the first menu item (ie. the first row) 1304 enables the clipart selector 114.

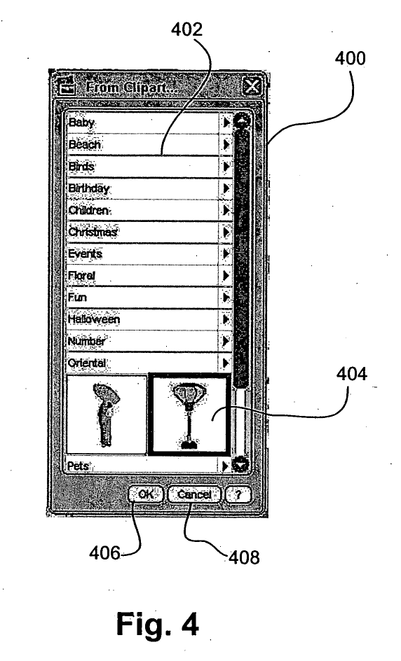

FIG. 4 shows an exemplary user interface 400 associated with the clipart selector 114. The interface 400 provides a clipart selection dialog that shows a list of clipart 402 available for selection by the user. Each clipart is represented by its thumbnail image in the list. For example, a flower image will represent a flower clipart. The user can select a clipart by clicking its representative image 404. The user can then click either the OK button 406 to confirm the selection or the CANCEL button 408 to discard the selection, and the dialog is dismissed.

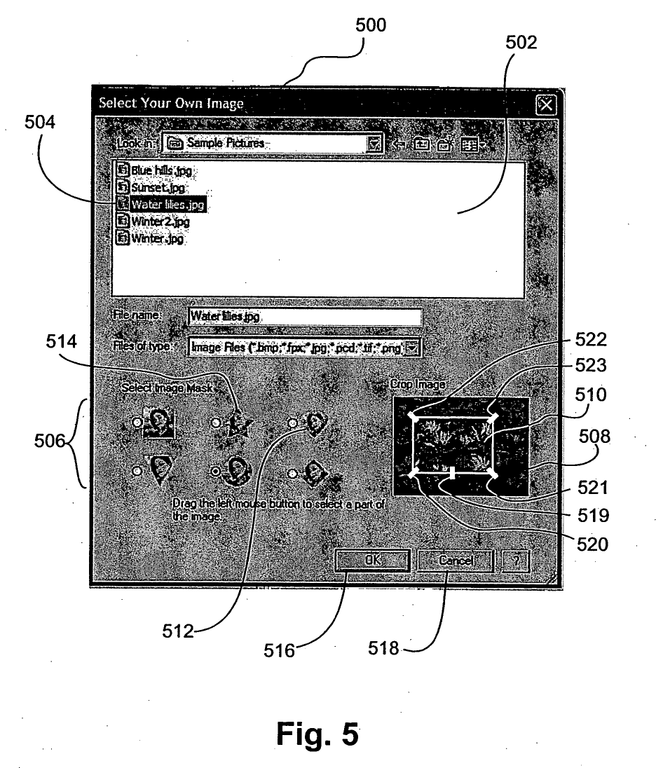

Clicking on the second menu item (second row) 1306 enables the mask image selector 116. FIG. 5 shows an exemplary user interface 500 associated with the mask image selector 116. The interface 500 provides a custom image selection dialog. The dialog contains three types of tasks—selecting a user image file list 502, applying a mask 506 onto the image, and cropping of an image preview 508. The selection of a user image file 504 from the list 502 is performed in a traditional fashion using an operating system of the computer 901. The user may desirably want only a portion of a custom image, for example, only the facial part of a human image, to be the decorative object. The cropping task provides a simple tool so that the user can crop the desirable part of the image. The task is to be conducted is presented to the user in an image preview area 508. Upon the user selecting a valid image file 504, the image is shown in the preview area 508. The user can then crop the image in the preview area 508 by dragging the mouse 903 over the desired portion of the image. This dragging generates a bounding box that defines the cropping area 510. The portion inside the bounding box is desirable and will be used as a decorative object. The user can move the cropping area by positioning the cursor inside the cropping area 510 and then holding down and dragging a left button of the mouse 903. The user can re-size the cropping box by holding down and dragging one of the resizing indicators 520, 521, 522 and 523 at the four corners of the box. The user can also change the orientation of the cropping box between portrait and landscape by clicking the orientation switcher 519.

The images in the list 502 are usually rectangular. It is not attractive to have a decorative object in a rectangular shape all the time. The masking task 506 provides a solution to contour the cropped image in a variety of shapes, such as heart shape 512, a star shape 514, and others as desired. The type of shape is termed a mask and such can be helpful for the user to prepare a decorative object in the design for particular occasions such as weddings and birth celebrations. The available masks are represented by a set of mutually exclusive “radio” buttons in the masking task 506. As illustrated, each “radio” button shows a selection icon and an associated mask image. The user can select one of the masks at any time by clicking its icon. Upon the user's selection of the mask, the mask is applied to the cropped image 510. The user can then either confirm the constructed decorative object by clicking the OK button 516 or discard the changes by clicking the CANCEL button 518. The interface 500 is then dismissed.

In certain cases, the user may not want a decorative graphical object in the design and yet not want to replace it either. Thus, the remove button 312 allows the user to remove such a decorative object.

The user can also delete all decorative objects and add personally chosen decorative objects quickly without going through the process of selecting a decorative object button and replacing it. Instead, the user can simply omit selecting a decorative object button. The system will add a generated particle to an empty slot automatically. A decorative object may be rotated on the layout to have a rotated appearance. The rotation button 322 allows the user to switch on or off the rotation of the selected decorative object.

As described, the user may choose a clipart 133 as a decorative object. A clipart 133 is an artwork that may have a set of pre-defined colours to be chosen. That is, a clipart-constructed decorative object can be in different colour forms. For example, a butterfly clipart can be customised to have either blue wings or yellow wings. These pre-defined colours are the best match to the object from the artistic perspective. On the user interface, a set of colour buttons 306 is used to re-colour of the clipart with these pre-defined colours (detail available on request). There is also a Custom button 310 that allows the user to choose a colour from a colour dialog if the user is not satisfied with pre-defined colours presented in the interface 300.

In the context of the above referenced published specifications, a decorative object may be treated as a particle upon which various visual effects processes may be applied. In the field of computer graphics it is often desirable to decorate or enhance given shapes to make them more visually interesting. An example of this may be for the purposes of advertising or web page design. This is done by adding texture to a region defined by a shape, such as filling the region with multiple instances of smaller objects, resulting in a more complex composite image. Circle packing provides such a texture.

Traditional circle packing methods obey the following general conditions:
(a) the packing is reasonably dense and evenly distributed across the region,
(b) circles are positioned so as to give the impression of random placement and avoid noticeable locally repeating patterns,
(c) circles do not intersect neighbouring circles,
(d) circles are tangential to and touch their nearest neighbours, and
(e) the packing is osculatory (ie any available area is always covered by the largest possible circle).

The particle effect operates to create such composite images from sub-images within a boundary (the sub-images not being restricted to circles) but, for aesthetic reasons, the above general conditions are relaxed. Further, the particle effect provides a spatial relationship followed by a parameter of the sub-images within the image boundary. For example, to further enhance the artistic effect it is often desirable to manipulate the packing density or properties of component circles dependent on their position with respect to reference objects or goals. For instance, it may be desired to vary the size of circles so that they increase in diameter in accordance with their vertical position, or to vary the density of the circles so that they are more densely packed towards the centre of the boundary. Traditional techniques are limited in that although they address the problem of even-distribution packing within a space, they do not provide for further manipulations of density or properties of components such as circles that the user may wish to apply. Given the computational nature of these algorithms, it is desired that such manipulations occur with a minimum of interaction from the user, but that the user also have reasonably precise control over the final result. The particle effect and the packing functions associated therewith afford the user such freedom.

In addition to manipulation of each individual decorative object, the user may adjust the layer setting controls 308 to facilitate a set of simple layout rules to control the way of laying-out or distribution the decorative objects in/on to the decorative space. A rule-based laying-out of the decorative objects gives the user the power to design various decorative patterns simply and easily. Such laying-out also shortens and simplifies the learning curve usually required to design an advanced pattern in other products, thereby advancing the user's expertise in an effortless manner. The laying out of the decorative objects is achieved through determining certain seed locations in the space at which the individual objects are to be positioned. The rules include:
(i) a decorative object-to-boundary space rule;
(ii) a decorative object-to-decorative object rule; and
(iii) a decorative object rule.

The decorative object-to-boundary space rule governs the relationship between the decorative objects and the space. Such may be used to effect a biasing of the decorative objects in a predefined manner about the space. Such can include distributing the decorative objects towards the centre of the space, distributing the decorative objects towards the boundary of the space and distributing the decorative objects towards a particular direction of the space. The decorative object-to-decorative object rule can be used to vary the spatial displacement of objects within the boundary. For example, such may apply a random distribution at different densities about the space. Alternatively, regular distributions, such as square-grid or diamond-grid, may be specified, also at appropriate densities. The decorative object rule can be used to create various graphical patterns. The user can select any one of the options at a time from a combination box 318 in the interface 300. The distributions are performed according to the principles of the above referenced published specifications.

The decorative object-to-decorative object rule governs the “strength” among the decorative objects. An object with more strength occupies space on its own more so than others with less strength. This effect is akin to electrostatic repulsion. The user can change the strength using the slider control 320 in the user interface 300. This can be achieved by scaling between 0-100% strength for lower and upper bounds which are mapped onto 0-100%.

The decorative object rule governs the size of the decorative objects. The user can change the size of the decorative objects by the slider control 316 in the user interface 300. This can be done with object scaling from 0-100% for its lower and upper bounds which are mapped onto 0-100%. This rule can also be used to vary object-specific parameters such as rotation and transparency.

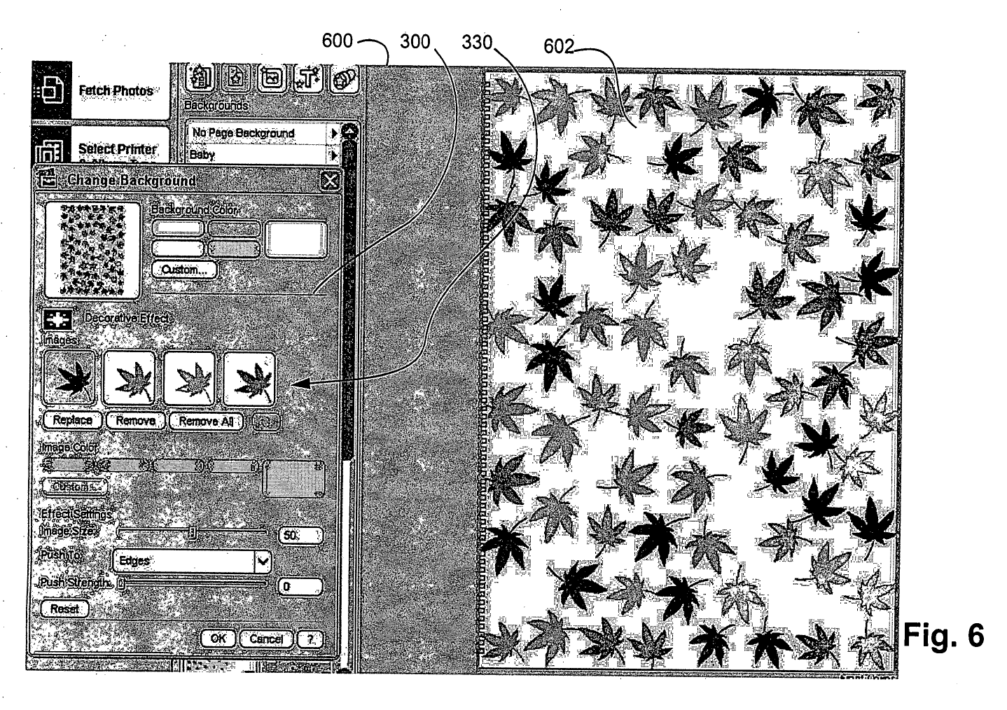

FIG. 6 shows a view area 602 that represents part of the screen display 600 of the display device 914. The interface 300 will be seen as part of the display 600, in this example. Any change to the decorative effect will be reflected on the view area 602 and which represents the rendering retained by the memory image 123. Specifically, the 300 in FIG. 6 shows four different images 330 used for creating the view 602. Whilst each of the images 330 depicts a maple leaf, each has a different colour and is instantiated in the view area 602 are different sizes and rotations. This can be performed in the fashion described above with respect to change events.

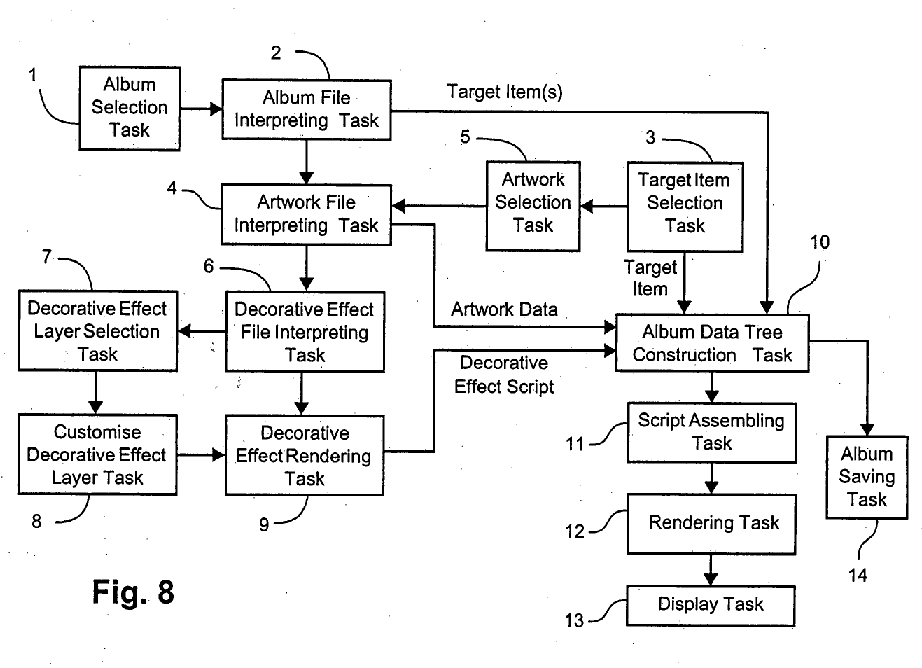

FIG. 8 illustrates a task modular diagram representing the particular flow 800 of tasks performed in the system 100. An album selection task 801 is a task in which the user loads a previously saved album file from the external storage device 104. Subsequently, an album file interpreting task 802 is performed to parse and translate the data from the file into hierarchical memory data objects forming the tree 119. The task 802 passes the control to an artwork interpreting task 804 when the artwork file 127 is detected in the album. The task 804 then loads, parses and translates the artwork file into artwork hierarchical memory data objects. The task 804 may detect the decorative effect information in the artwork and pass the decorative effect file to a decorative effect file interpreting task 806. The task 806 loads, parses and translates the file into decorative effect hierarchical memory data objects. The task 806, on one hand, signals a decorative effect layer selection task 807 to allow the user to perform layer selection and to customise the decorative effect in a customise decorative effect layer task 808. On the other hand, the task 806 passes the decorative effect memory data objects to a decorative effect rendering task 809 to generate the rendering script, that describes the decorative effect. An album data tree construction task 810 is fed with the target item(s), the item-associated artwork data objects and the artwork-associated decorative effect script to construct a hierarchical album memory data tree. Any change to the album tree triggers a change event resulting in a re-rendering of the tree to preview the effect. A script assembling task 811 is then signalled to process the album tree, generate the rendering scripts, for various objects in the tree, and assembles the generated scripts along with the existing scripts (eg. decorative effect script) into a complete rendering script document that can be interpreted by a rendering task 812. The task 812 interprets and renders the script document into a memory image. The memory image is then passed to the display task 13 which displays the image on the display device. From the task 810, an album saving task 814 allows the user to save the album data tree as an album file on an external storage device. With an opened album, a target item selection task 803 allows the user to add new target item(s) onto the album. An artwork selection task 805 allows the user to select an artwork for the selected target item. The task 805 then invokes the artwork file interpreting task 804 to execute the same sequence of the tasks as described above.

Appendix A shows an example of artwork file containing decorative effect information. Appendix A defines a geometric shape and flags the shape to be decorated (“glorified” in the language of the artwork file). Appendix A also defines which decorative effect file is to be used to decorate the decorative-flagged geometric shape.

Appendix C is an example of decorative effect file which is referenced to by the artwork file in Appendix A. The file of Appendix C contains a user layer which comprises related effect parameters, including decorative objects (image files), which are to be used for distributing onto the geometric shape(s) defined by the artwork in Appendix A. Such a layer has a set of layer-wide parameters (in a packing section and a placement section) and a collection of decorative objects which have their own controlling parameters. The distribution rules are parameterized from the layer information for instantiation in the geometric shape(s) of the artwork. A subset of parameters defined in the file is arranged to be exposed to a user for manipulating through the relevant GUI (FIGS. 3 to 5).

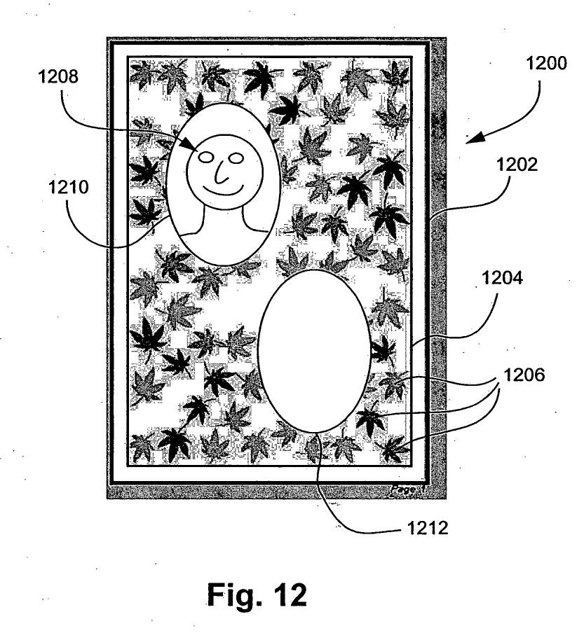

FIG. 12 shows an example 1200 of a page background (being in this case the relevant target item 101) being decorated with the artwork defined by the file of Appendix A, which in turn references the decorative effect file of Appendix C. The parameters defined in the decorative effect file along with the geometric shape (space) defined in the artwork is applied to the distribution rules to result in the pattern of the decorative objects distributed within the geometric shape (space). As illustrated, a page item 1202 has arranged within a page background 1204, being a rectangular geometric shape defined by the artwork file of Appendix A. Decorative objects 1206, being sourced from image files, are defined by the decorative effect rule of Appendix C. As also illustrated, the example also includes two further geometric shapes, being ovals 1210 and 1212 which represent windows in which digital images (photographs) may be positioned to create a page of a photo album. In this instance, an image 1208 of a person has been place in the oval 1210. As a consequence the decorative artwork formed by the page background and incorporating the objects 1206 and the ovals 1208, 1212 provide frames for the inserted digital images.

Given the above structural and functional description of the system 100, it is now possible to describe the internal workflow of decorative effect manipulation used in the system 100. The present workflow description also covers a generalised framework of digital photo album generation so that such may extended to include the other internal workflows of the related functionalities in the future.

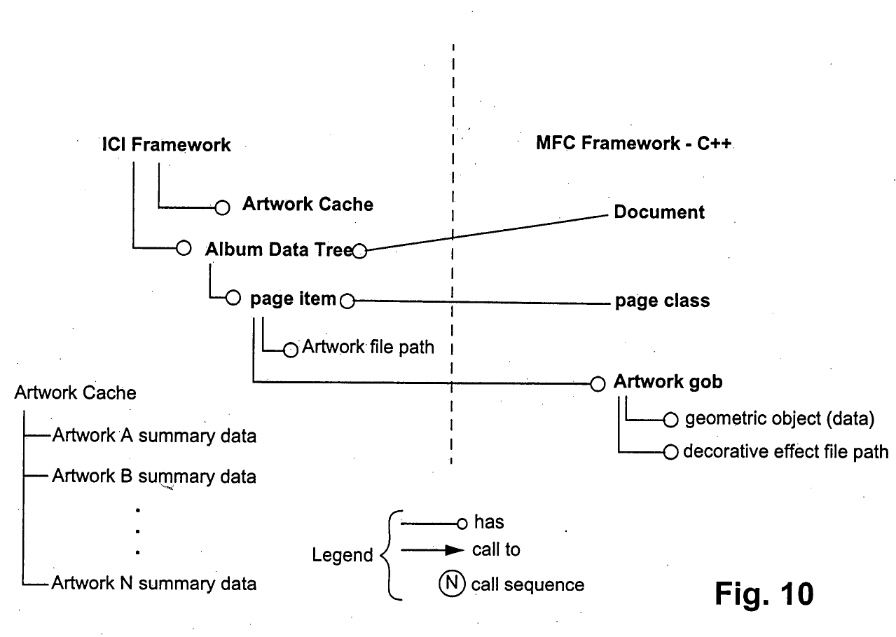

The system 100, in one specific implementation, forms part of a digital photo album generation software application (hereinafter the “album application”) which, as seen in FIG. 10, is configured to operate in a Microsoft Windows™ operating system with Microsoft Foundation Class (MFC) coding framework, typically written in the C++ programming language. In the implementation, generally depicted in FIG. 10, a general-purpose interpretive programming language and application entitled “ICI” is used to configure and process the relevant scripts, object definitions and artwork data into page descriptions suitable for interpretation and processing by rendering application and/or hardware. ICI has dynamic typing and flexible data types with the flow constructs and operators of C, and is publicly available at www.SourceForge.net/projects/ici and is also disclosed in U.S. Pat. No. 6,020,899 (Long) granted Feb. 1, 2000. Accordingly, the ICI item objects of the ICI album data tree in the ICI framework have their C++ counterparts. That is, for each ICI item object (ie. page, photo, text and clipart), a corresponding C++ class object exists and has a reference to the ICI item object. The C++ class object integrates with the Microsoft MFC framework and presents the visual and interactive aspects based on the information out of the ICI item object. To explain how the system 100 works, it is appropriate to consider a simple example of an album containing a single page item which has a page background artwork attached. The background artwork contains decorative effect information. As such, the memory (eg. 906, 910) of the computer 901 when implementing the album application can have an initial data configuration as shown in FIG. 10.

The album application is preferably implemented as an MFC document. The album document constructs an album data tree and has a reference to the tree. The album document also creates a C++ counterpart class object for each item in the tree. In this example, it is an MFC page class object that has a reference to the ICI page item. Meanwhile, the ICI page item holds a reference to its C++ artwork gob class that is instantiated from the artwork file used for the page item. An artwork gob class is a complete version of instantiated artwork file.

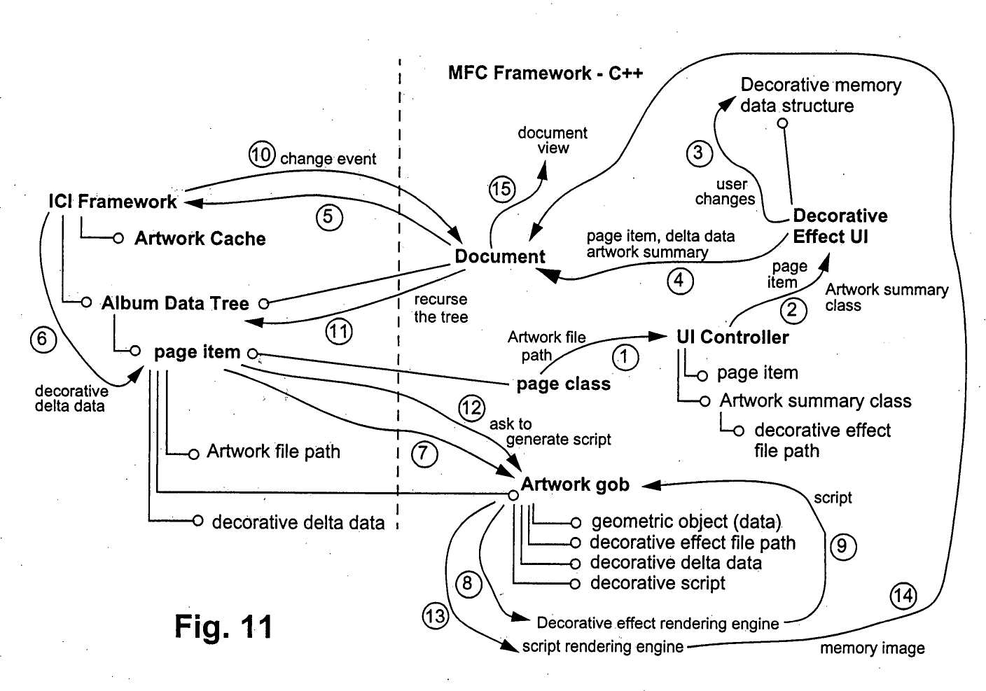

The exemplary steps performed in decorating the single page item can be best understood with reference to the dynamic and interactive configuration FIG. 11 and the sequential steps referred to therein and described below.

Step 1: A UI controller is signalled when the user selects the page (represented by page class). The controller gets the artwork file path from the page item through its corresponding page class. The UI controller then creates an artwork summary class object from the ICI artwork cache based on the artwork file path. An artwork contains numerous data information. Some of the information is essential for the system 100 to know at any time. Accordingly, these kinds of information are stored in the artwork cache, seen in FIG. 10 but omitted from FIG. 11 for clarity. In the other words, the artwork cache is a list of artwork summary data. Each of the artwork summary data contains a subset of data of an artwork file. The advantage of this cache is that the system 100 knows the essential information of all artworks in the system 100 without a need to load all artwork files, each of which may be quite large. Such an arrangement saves memory usage and the affords better performance. This cache operates whilst the system 100 starts.

Step 2: From the artwork summary data, the artwork gob described above is created when a selection on it is made either by system default or from a selection by the user. Back to the artwork summary class object, it contains the decorative effect file path as one of its attributes. The UI controller checks if the artwork summary class object contains the valid decorative effect file path. If so, the controller passes the page item and the artwork summary class object to the decorative effect UI.

Step 3: The decorative effect UI then loads the decorative effect file into the memory decorative data structure.

Step 4: The decorative effect UI, on loading the memory data structure, presents the default values in the UI ready for the user to change. The user is able to add/replace decorative objects as well as to change the parameters through the UI. The UI makes any user's change to the memory decorative data structure, gets the decorative delta data out of the memory decorative data structure and then signals the document the changes by passing the page item, the artwork summary class and the decorative delta data to the document. The decorative delta data is the data exposed to the user and to which user changes are applied.

Step 5: The document then calls the ICI framework with the page item, the artwork file path (out of the artwork summary class) and the decorative delta data.

Step 6: The ICI framework in turn adds the delta data to the page item.

Step 7: The ICI framework then calls the page item's artwork gob with the delta data. The artwork gob has knowledge of the decorative effect file path and the geometric objects to be decorated.

Step 8: With the passed-in decorative delta data, the artwork gob calls on the decorative effect rendering engine to render the information into the script. The decorative effect rendering engine loads the decorative effect file into the memory decorative data structure, overwrites the structure with the decorative delta data and then applies the decorative data structure and the geometric object data (space) to its effect rules (algorithms) to output a script which is a descriptive of the distribution pattern of decorative effect.

Step 9: The script is returned to the artwork gob which in turn returns to the ICI framework via the page item and album data tree.

Step 10: The ICI framework then signals a change event to the document.

Step 11: The document then goes through the entire album data tree recursively to permit each item in the tree the opportunity to generate a corresponding script.

Step 12: In the present example, the page item calls its artwork gob to generate the script. The artwork gob generates its script integrating the decorative script obtained previously.

Step 13: The artwork gob then requests the script rendering engine to render its script into a memory image. The script rendering engine renders the script to a memory image in a background thread.

Step 14: The resultant memory image is passed to the document.

Step 15: The document composites the memory image to a document view screen, being the display 914.

It will be appreciated from the above that the system 100 offers unsophisticated users of graphical design tools the ability, through the manipulation of user-variable layers composited over fixed layer, with the ability to easily create and edit artwork designs for a variety of purposes.

### EXAMPLE

A decorative effect is applied on the geometric shape defined in the artwork. There are different types of artworks for different types of target items. That is, there are background artworks for page item type, photo frame artworks for the photo image item type, and text frame artworks for text strings. In order to illustrate the formation of an artwork according to the preferred implementation, reference is now made to the GUIs of FIGS. 14B to 141 where the creation of a page of a photo album is depicted. To decorate a page, the following steps are required:
(i) accessing a target item, for a page target item, either selecting an existing page or creating a new page and selecting that page;
(ii) selecting a corresponding type of artwork, which contains decorative effect information, for the selected target item; and
(iii) accessing the decorative effect UI to change the decorative effect.

Decorative effect in the exemplary photo album application is a function to decorate an artwork and therefore the decorating process may not require involvement of any (digital) photograph.

Referring to FIGS. 14B to 141, the following is an example of decorating the background of a page item in a hosting system, such as the system 100 operating in the computer 900:
1. As seen in FIG. 14B, the photo album application commences with a GUI showing a single page item 1408 which may be selected by the user by clicking on the page item 1410 using the mouse 903. A thumbnail representation 1408 of the album being created is also displayed in the GUI. In this instance, since the album has only one page, there is only one thumbnail shown;
2. The user may then selecting to change to a “Decorative Album” tab 1412, and selecting background type of artwork by its icon 1414, as seen in FIG. 14C. A list of background artworks is shown to the user in the GUI of FIG. 14C. The user selects one of the background decorative effect artworks, and this is applied to the page as seen at 1416;
3. The user can then click the “Change” button 1418 seen in FIG. 14C;
4. The decorative effect change GUI 1420 is then displayed, as shown in FIG. 14D. This corresponds with that previously described with respect to FIG. 3;
5. As shown in FIG. 14E, the user can now change the decorative effect and the changes are taken effect in the page item 1422. In this example, the decorative changes involve increasing the “push” strength (from 0 in FIG. 14D to 80 in FIG. 14E) of the individual particles thereby disbursing the corresponding maple leaf objects apart. A further effect applied to the page 1422 is a size-based blend (ie. “push to”) diagonally across the page that alters the size of the instantiated maple leaf objects from infinitesimal, and hence invisible, in the lower left corner, to a determined size (ie. 50 as per the GUI) in the upper right corner; and
6. At this stage, decorating a page background is done and without involving any photograph, such being a foreground object.

Where desired, the user may then add a photo image to the page whose background is decorated. The following steps may then be performed:
7. Changing to a fetch photos tab 1426 as shown in FIG. 14F;
8. Clicking a “Fetch Photos” button 1428 and a file selection dialog 1430 is displayed as seen in FIG. 14G. A photo image may then be selected and imported into the album by clicking an Open button 1432 in the dialog 1430;
9. As seen in FIG. 14H, the selected photo image 1434 is added onto the page of FIG. 14F, which may now be referred to as the page 1434.
10. The user can then choose a photo frame artwork (border) 1436 for the photo image 1434 from a list 1438 of photo frame artworks as shown in FIG. 141. This may be done by changing to a Decorate Album tab 1442, clicking on a desired photo frame type icon 1444 from the list 1438. The photo image 1434 is then framed by the framing artwork 1436. A page image 1440 is thus created. In the case of the frame artwork 1436 containing decorative effect information, the user can use the same process (step 3-5) to alter the framing artwork 1436.

For the creation of a decorative text string, the same process is achieved by applying a text frame artwork to the text string. In such an instance, the user picks a text frame artwork from a list of text frame artworks.

### INDUSTRIAL APPLICABILITY

The system described is applicable to the computer and data processing industries and particularly to software applications for the artistic presentation of information according to a layout. This can include the creation of photo albums and other forms of document production, according to “best” presentation aesthetic standards.

The foregoing describes only some embodiments of the present invention, and modifications and/or changes can be made thereto without departing from the scope and spirit of the invention, the embodiments being illustrative and not restrictive.

Appendix A: An Example of Decorative Artwork File

```
#kit-2.0
auto doc=[struct
closed=0,
fname=“Art\glorious\\Backgrounds\\Spring Leaves.kit”,
gobs=[array
  [struct
  closed=1,
  gobs=[array
  [struct
  closed=1,
  edges=[array
    [struct
    open=0,
    points=[array
    [struct b=1,ix=−0.019534,iy=−0.023256,mx=−0.019534,my=−0.023256,
            ox=−0.019534,oy=−0.023256,],
    [struct b=0,ix=−0.019534,iy=297.000000,mx=−0.019534,my=297.000000,
            ox=−0.019534,oy=297.000000,],
    [struct b=1,ix=297.024899,iy=297.059884,mx=297.024899,my=297.059884,
            ox=297.024899,oy=297.059884,],
    [struct b=1,ix=297.024899,iy=0.026744,mx=297.024899,my=0.026744,
            ox=297.024899,oy=0.026744,],
    ],
  ],
  ],
  editable=0,
  fdontantialias=0,
  fill=“flat”,
  flabo=[array 98.733116,−7.458602,22.789532,100.000000,],
  fstyle=“oe”,
  name=“ | Recolour yes”,
  pr_art=[struct
  recolouring=“recolourable”,
  ],
saveable=0,
slottype=“art”,
what=“shape”,
],
[struct
closed=1,
editable=0,
gobs=[array
  [struct
  closed=1,
  edges=[array
  [struct
  open=0,
  //// now define a page background area (ie. geometric shape)
  points=[array
    [struct b=0,ix=−0.180000,iy=297.059884,mx=−0.180000,my=297.059884,
            ox=−0.180000,oy=297.059884,],
    [struct b=1,ix=297.024899,iy=297.059884,mx=297.024899,my=297.059884,
            ox=297.024899,oy=297.059884,],
    [struct b=0,ix=297.024899,iy=−0.023256,mx=297.024899,my=−0.023256,
            ox=297.024899,oy=−0.023256,],
    [struct b=1,ix=−0.003810,iy=−0.004804,mx=−0.003810,my=−0.004804,
            ox=−0.003810,oy=−0.004804,],
  ],
  ],
  ],
  editable=0,
  fdontantialias=0,
  fstyle=“oe”,
  name=“GEL: Gob glorious | Gob glorious ”,
  ////// now flag the geometric shape to be decorated
  pr_art=[struct
  glorious=“true”,
  ],
  saveable=0,
  scap=“butt”,
  sdash=[array 0.000000,],
  sdash_dont_scale=1,
  sfill=“strokeover”,
  sjoin=“round”,
  slottype=“art”,
  smiter_limit=10.000000,
  swidth=1.000000,
  swidth_dont_scale=1,
  what=“shape”,
  ],
],
name=“”,
op=“over”,
pr_art=[struct
  hmap=“stretch”,
  vmap=“stretch”,
],
saveable=0,
slottype=“art”,
what=“group”,
],
[struct
closed=1,
edges=[array
  [struct
  open=0,
  points=[array
  [struct b=1,ix=19.947809,iy=276.405485,mx=19.947809,my=276.405485,
            ox=19.947809,oy=276.405485,],
  [struct b=1,ix=277.057555,iy=276.405485,mx=277.057555,my=276.405485,
            ox=277.057555,oy=276.405485,],
  [struct b=1,ix=277.057555,iy=20.667523,mx=277.057555,my=20.667523,
            ox=277.057555,oy=20.667523,],
  [struct b=1,ix=19.947809,iy=20.667523,mx=19.947809,my=20.667523,
            ox=19.947809,oy=20.667523,],
  ],
  ],
],
fdontantialias=0,
fstyle=“oe”,
name=“ | Gob AutoLayout”,
pr_art=[struct
  autolayout_area=“true”,
],
  what=“shape”,
],
[struct
closed=1,
edges=[array
  [struct
  open=0,
  points=[array
  [struct b=1,ix=−45.390461,iy=245.872263,mx=−45.390461,my=245.872263,
            ox=−45.390461,oy=245.872263,],
  [struct b=1,ix=−10.112683,iy=245.872263,mx=−10.112683,my=245.872263,
            ox=−10.112683,oy=245.872263,],
  [struct b=1,ix=−10.112683,iy=210.594485,mx=−10.112683,my=210.594485,
            ox=−10.112683,oy=210.594485,],
  [struct b=1,ix=−45.390461,iy=210.594485,mx=−45.390461,my=210.594485,
            ox=−45.390461,oy=210.594485,],
  ],
  ],
],
name=“ | Gob Thumb”,
pr_art=[struct
  thumb_region=“true”,
],
what=“shape”,
],
],
name=“ | Artwork Border A Spring Leaves (Decorative Effects) [glorious file] | Has
    rcmd clrs | Art recolour | Gob OP ”,
  op=“over”,
  pr_art=[struct
  complete=1,
  frame_path=“”,
////// define to use this decorative effect file to decorate the flagged geoometric shape
  glorious_file=“Backgrounds\\spring_leaves.xml”,
  group=“Decorative Effects”,
  name=“A Spring Leaves”,
  recolour_base=[array 98.733100,−7.458600,22.789500,100.000000,],
  recolour_base_L=“98.7331”,
  recolour_base_Lab=[array 98.733100,−7.458600,22.789500,],
  recolour_base_a=“−7.4586”,
  recolour_base_b=“22.7895”,
  recolour_rcmd_colour_0=[array 98.733100,−7.458600,22.789500,100.000000,],
  recolour_rcmd_colour_0_L=“98.7331”,
  recolour_rcmd_colour_0_a=“−7.4586”,
  recolour_rcmd_colour_0_b=“22.7895”,
  recolour_rcmd_colour_1=[array 95.957500,−20.232900,18.998000,100.000000,],
  recolour_rcmd_colour_1_L=“95.9575”,
  recolour_rcmd_colour_1_a=“−20.2329”,
  recolour_rcmd_colour_1_b=“18.998”,
  recolour_rcmd_colour_2=[array 100.000000,0.000000,0.006124,100.000000,],
  recolour_rcmd_colour_2_L=“100”,
  recolour_rcmd_colour_2_a=“0”,
  recolour_rcmd_colour_2_b=“0.006124”,
  recolour_rcmd_colour_3=[array 95.128000,9.710910,−7.206480,100.000000,],
  recolour_rcmd_colour_3_L=“95.128”,
  recolour_rcmd_colour_3_a=“9.71091”,
  recolour_rcmd_colour_3_b=“−7.20648”,
  recolour_rcmd_colour_4=[array 80.000000,0.000000,0.000000,100.000000,],
  recolour_rcmd_colour_5=[array 80.000000,0.000000,0.000000,100.000000,],
  recolour_recommended=[array
  [struct
    L=98.733100,
    a=−7.458600,
    b=22.789500,
  ],
  [struct
    L=95.957500,
    a=−20.232900,
    b=18.998000,
  ],
  [struct
    L=100.000000,
    a=0.000000,
    b=0.006124,
  ],
  [struct
    L=95.128000,
    a=9.710910,
    b=−7.206480,
  ],
  ],
  recolourable_overall=“true”,
  render_op=“true”,
  tframe_path=“”,
  type=“page border”,
  use_recolour_rcmd_colour_4=“true”,
  use_recolour_rcmd_colour_5=“true”,
  ],
  slottype=“art”,
  what=“group”,
  ],
  [struct
  closed=0,
  gobs=[array
  [struct
  a=1.000000,
  b=0.000000,
  c=0.000000,
  closed=1,
  d=1.000000,
  dh=35.277778,
  dv=35.277778,
  editable=0,
  fname=“\\Backgrounds\\Spring_Leaves_b.jpg”,
  name=“”,
  saveable=0,
  tx=−45.307909,
  ty=210.594485,
  what=“image”,
  ],
  ],
  op=“over”,
  what=“group”,
  ],
],
guides=[array
  [struct
  hidden=0,
  locked=0,
  orientation=“vertical”,
  position=113.501549,
  ],
  [struct
  hidden=0,
  locked=0,
  orientation=“vertical”,
  position=183.503815,
  ],
  [struct
  hidden=0,
  locked=0,
  orientation=“horizontal”,
  position=183.519447,
  ],
  [struct
  hidden=0,
  locked=0,
  orientation=“horizontal”,
  position=113.517181,
  ],
],
height=297.000000,
op=“over”,
pr_art=[struct
  distribute=“true”,
  version=2,
],
printing=[struct
  auto=1,
  croplength=5.000000,
  cropsmall=1,
  height=420.000000,
  joins=1,
  overlap=3.000000,
  scale=100.000000,
  width=297.000000,
  ],
render_color_space=“Lab”,
ruler=0,
save_relative_path=0,
save_unc_path=1,
what=“group”,
width=297.000000,
];
```

Appendix B

#[document 0 0 100 100
#[page
gc_color(1, 1, 1, 0, 0, 0, 0, 0, 100, 100);
gc_opacity(1.0);
page = page_fill( );
#]page
#]document

Appendix C: An Example of Decorative Effect File

```
<glorious-effect ver=“1.0” name=“Sample”>
////// define a (user) layer here
  <layer name=“selected user layer” position=“0”>
    <effectparams index=“0” effect=“particle” type=“fill”>
      <particle-effect>
////// define layer-wide parameters
        <packing>
          <size min=“15.000” max=“20.000” low=“12.000” high=“89.000”/>
          <spacing value=“50.000” low=“12.000” high=“78.000”/>
          <eccentricity value=“56.000” low=“10.000” high=“90.000”/>
          <randomiser value=“78”/>
        </packing>
        <placement strength=“10.000” low=“10.000” high=“85.000” bias=“to_edge”
                  directionangle=“45.000” trim=“0” trimsize=“50.000” separatebysize=“0”/>
        <render-order order=“direction” directionangle=“45.000” inturn=“0”/>
////// define a set of decorative objects of the layer
        <graphic-collection>
////// define a decorative object and its parameters
          <graphic index=“0” file=“\Particles\leafs\cdc_maple_green.fpx” x=“32” y=“32”>
            <instances max=“1” unlimited=“0”/>
            <towards strength=“0.000” low=“0.000” high=“100.000” towardsangle=“0.000”/>
            <toedge strength=“0.000” low=“0.000” high=“100.000”/>
            <tilt strength=“0.000” low=“0.000” high=“100.000” tiltangle=“0.000”/>
            <centre strength=“0.000” low=“0.000” high=“100.000”/>
            <random strength=“100.000” low=“0.000” high=“100.000”
                      randomangle=“360.000”/>
            <swirl strength=“0.000” low=“0.000” high=“100.000”/>
            <anchor anchorx=“0.000” anchory=“0.000” scale=“1.000”/>
          </graphic>
          <graphic index=“1” file=“\Particles\leafs\cdc_maple_light_green2.fpx” x=“32”
                    y=“32”>
            <instances max=“1” unlimited=“0”/>
            <towards strength=“0.000” low=“0.000” high=“100.000” towardsangle=“0.000”/>
            <toedge strength=“0.000” low=“0.000” high=“100.000”/>
            <tilt strength=“0.000” low=“0.000” high=“100.000” tiltangle=“0.000”/>
            <centre strength=“0.000” low=“0.000” high=“100.000”/>
            <random strength=“100.000” low=“0.000” high=“100.000”
                      randomangle=“360.000”/>
            <swirl strength=“0.000” low=“0.000” high=“100.000”/>
            <anchor anchorx=“0.000” anchory=“0.000” scale=“1.000”/>
          </graphic>
          <graphic index=“2” file=“\Particles\leafs\cdc_maple_light_green.fpx” x=“32”
                    y=“32”>
            <instances max=“1” unlimited=“0”/>
            <towards strength=“0.000” low=“0.000” high=“100.000” towardsangle=“0.000”/>
            <toedge strength=“0.000” low=“0.000” high=“100.000”/>
            <tilt strength=“0.000” low=“0.000” high=“100.000” tiltangle=“0.000”/>
            <centre strength=“0.000” low=“0.000” high=“100.000”/>
            <random strength=“100.000” low=“0.000” high=“100.000”
                      randomangle=“360.000”/>
            <swirl strength=“0.000” low=“0.000” high=“100.000”/>
            <anchor anchorx=“0.000” anchory=“0.000” scale=“1.000”/>
          </graphic>
          <graphic index=“3” file=“\Particles\leafs\cdc_maple_green2.fpx” x=“32” y=“32”>
            <instances max=“1” unlimited=“0”/>
            <towards strength=“0.000” low=“0.000” high=“100.000” towardsangle=“0.000”/>
            <toedge strength=“0.000” low=“0.000” high=“100.000”/>
            <tilt strength=“0.000” low=“0.000” high=“100.000” tiltangle=“0.000”/>
            <centre strength=“0.000” low=“0.000” high=“100.000”/>
            <random strength=“100.000” low=“0.000” high=“100.000”
                  randomangle=“360.000”/>
            <swirl strength=“0.000” low=“0.000” high=“100.000”/>
            <anchor anchorx=“0.000” anchory=“0.000” scale=“1.000”/>
          </graphic>
        </graphic-collection>
      </particle-effect>
    </effectparams>
  </layer>
</glorious-effect>
```

Appendix D: An Example of the Album File

```
auto album=[struct
application_version=[array 2,0,0,27,],
back_cover=0,
current_theme=“ No theme”,
fname=“C:\\Documents and Settings\\chriss\\My
Documents\\album_pat.alb”,
front_cover=0,
margins=[struct
  bottom=10.000000,
  left=10.000000,
  right=10.000000,
  top=10.000000,
],
min_app_version=[array 2,0,],
pages=[array
[struct
  autolayout_rect=[struct
  xmax=187.235085,
  xmin=22.867499,
  ymax=267.741861,
  ymin=29.292060,
],
border_rect=[struct
  xmax=200.000000,
  xmin=10.000000,
  ymax=287.000000,
  ymin=10.000000,
],
distribution=[array 4,],
glorious_info=[array
[struct
  glorious_file=“Backgrounds\\spring_leaves.xml”,
  layer_info=[struct
///// following are the layer-wide parameters the user has changed
    bias_direction=45.000000,
    bias_option=2,
    bias_strength=10.000000,
    bias_strength_high=85.000000,
    bias_strength_low=10.000000,
    selected=1,
    size1=15.000000,
    size1_ref=15.000000,
    size2=20.000000,
    size2_ref=20.000000,
    user_layer_id=1,
    ],
    par_info_array=[array
///// user-selected clipboard as the decorative object
    [struct
    L=38.769083,
    a=56.876718,
///// clipboard selected
    artwork_file=“Nippon2\\clipart\\01_nippon2_ca_geisha.kit”,
    b=53.294329,
    is_tilted=0,
///// decorative object image file generated from the clipart
    particle_file_path=“\\par_page_1_529155942_export.fpx”,
    particle_index=0,
    size=1.000000,
    size_factor=0.500000,
    tilt=0.000000,
    type=1,
    ],
    [struct
    is_tilted=0,
    particle_file_path=“\\Particles\\leafs\\cdc_maple_light_{—}
    green2.fpx”,
    particle_index=1,
    size=1.000000,
    size_factor=0.500000,
    tilt=0.000000,
    type=0,
    ],
    [struct
    is_tilted=0,
    particle_file_path=“\\Particles\\leafs\\cdc_maple_light_green.fpx”,
    particle_index=2,
    size=1.000000,
    size_factor=0.500000,
    tilt=0.000000,
    type=0,
    ],
    [struct
    is_tilted=0,
    particle_file_path=“\\Particles\\leafs\\cdc_maple_green2.fpx”,
    particle_index=3,
    size=1.000000,
    size_factor=0.500000,
    tilt=0.000000,
    type=0,
    ],
    ],
  ],
  ],
  height=297.000000,
  is_selected=1,
  layout=11,
  page_nbr=1,
  photo_size_factor=0.800000,
  photos=[array ],
  porder_L=98.733117,
  porder_a=−7.458616,
  porder_art_path=“glorious\\Backgrounds\\Spring Leaves.kit”,
  porder_b=22.789544,
  type=“page”,
  user_applied_art=1,
  variation_id=0,
  width=210.000000,
  ],
  ],
  printer_settings=[struct
  orientation=“portrait”,
  page_height=297.000000,
  page_width=210.000000,
  paper_id=9,
  paper_length=297.000000,
  paper_width=210.000000,
  printer_name=“\\\\lite\\Prima”,
  ],
  title=“Untitled”,
];
```

1. A graphical representation formed of at least one template having a plurality of graphical objects arranged in a predetermined number of rendering layers spanning a geometric space, at least one of said layers having user-alterable parameters and incorporating at least one multiply instantiated user-definable graphical object distributed upon said at least one layer according to application of said parameters to a plurality of presentation rules.

2. A graphical representation according to claim 1 wherein said presentation rules are selected from the group consisting of:
(i) a rotation of said one graphical object;
(ii) a size of said one graphical object;
(iii) a transparency said one graphical object; and
(iv) a distribution of said one graphical object about said geometric space.

3. A graphical representation according to claim 2 wherein said distribution is determined by one of:
(a) a random distribution of seed locations about said geometric space;
(b) a regular distribution of seed locations about said geometric space;
(c) a biasing of seed locations according to a boundary of said geometric space; and
(d) a strength relationship between objects in said geometric space.

4. A graphical representation according to claim 3 wherein said biasing of said seed locations is one of:
(ca) a bias towards one of an inner or outer edge of said geometric space;
(cb) a bias to a centroid of said geometric space; and
(cc) a bias to a user-definable direction within said geometric space.

5. A graphical representation according to claim 1 wherein said geometric space includes at least one geometric shape, with said presentation rules being applied with said at least one shape.

6. A graphical representation according to claim 1 wherein associated with each said presentation rule is at least one user-modifiable parameter configured to alter a visual effect of said template.

7. A graphical representation according to claim 1 wherein said predetermined number of rendering layers comprise:
at least one user-modifiable layer upon which said at least one graphical object is formed; and
at least one fixed layer incorporating a corresponding predetermined graphical enhanced effect.

8. A method for forming a graphical representation from a template having a plurality of graphical objects arranged in a predetermined number of rendering layers spanning a geometric space, said method comprising the steps of:
(a) accessing at least one user-manipulable effect definition associated with one of said rendering layers, said effect definition including parameter information defining characteristics of said one layer;
(b) modifying the parameter information of said effect definition to thereby incorporate a multiply instantiated user-definable graphical object distributed across said one layer according to a plurality of presentation rules;
(c) generating a script of a graphical design formed by said layers;
(d) rendering the script into a viewing memory image; and
(e) outputting the memory image to a display device to thereby reproduce said graphical representation.

9. A method according to claim 8 further comprising the steps, before step (a), of:
(g) accessing a target item; and
(h) accessing an artwork associated with said target item.

10. A method according to claim 8 wherein said target item is one selected from the group consisting of a page item, an image item, and a text string item.

11. A method of decorating a geometric space, said method comprising the steps of:
(a) accessing a target item;
(b) accessing an artwork template associated with said target item and having at least one of a predetermined plurality of rendering layers spanning said geometric space;
(c) assigning said target item to one said artwork template corresponding to a fixed one of said layers;
(d) accessing decorative effect information of said artwork template corresponding to a user-manipulable one of said layers, said template having user-alterable parameters;
(e) manipulating said user-alterable parameters to provide at least one multiply instantiated user-definable graphical object distributed within said one manipulable layer according to application of said parameters to a plurality of presentation rules;
(f) generating and assembling a renderable script from descriptions of said layers; and
(g) rendering and displaying said script to reveal said decorated space.

12. A method according to claim 11, wherein said user-definable graphical object is formed of at least one of:
(i) a clipart; and
(ii) a selectable custom image.

13. A method according to claim 12, wherein step (e) comprises re-coloring said clipart object according to the steps of:
(ea) displaying a set of colors;
(eb) enabling access to one of said colours; and
(ec) applying the accessed colour to the clipart object.

14. A method according to claim 12, wherein the user-definable object is constructed from a custom image, and step (e) comprises the steps of:
(ed) accessing said custom image from an image list;
(ee) cropping the custom image to contain a desired portion of the original image; and
(ef) framing the cropped image with a framing artwork, said framing artwork being one of a square, a star, a heart, a triangle, an oval, and a diamond.

15. A computer program element comprising computer program code means to make a computer execute a procedure to create a graphical representation from a template having a plurality of graphical objects arranged in a predetermined number of rendering layers spanning a geometric space, said program code means comprising:
code for accessing at least one user-manipulable effect definition associated with one of said rendering layers, said effect definition including parameter information defining characteristics of said one layer;
code for modifying the parameter information of said effect definition to thereby incorporate a multiply instantiated user-definable graphical object distributed across said one layer according to a plurality of presentation rules;
code for generating a script of a graphical design formed by said layers;
code for rendering the script into a viewing memory image; and
code for outputting the memory image to a display device to thereby reproduce said graphical representation.

16. A computer program element comprising computer program code means to make a computer execute a procedure to decorate a geometric space, said program code means comprising:
code for accessing a target item;
code for accessing an artwork template associated with said target item and having at least one of a predetermined plurality of rendering layers spanning said geometric space;
code for assigning said target item to one said artwork template corresponding to a fixed one of said layers;
code for accessing decorative effect information of said artwork template corresponding to a user-manipulable one of said layers, said template having user-alterable parameters;
code for manipulating said user-alterable parameters to provide at least one multiply instantiated user-definable graphical object distributed within said one manipulable layer according to application of said parameters to a plurality of presentation rules;
code for generating and assembling a renderable script from descriptions of said layers; and
code for rendering and displaying said script to reveal said decorated space.

17. Computer apparatus adapted to decorate a geometric space, said apparatus comprising:
means for accessing a target item;
means for accessing an artwork template associated with said target item and having at least one of a predetermined plurality of rendering layers spanning said geometric space;
means for assigning said target item to one said artwork template corresponding to a fixed one of said layers;
means for accessing decorative effect information of said artwork template corresponding to a user-manipulable one of said layers, said template having user-alterable parameters;
means for manipulating said user-alterable parameters to provide at least one multiply instantiated user-definable graphical object distributed within said one manipulable layer according to application of said parameters to a plurality of presentation rules;
means for generating and assembling a renderable script from descriptions of said layers; and
means for rendering and displaying said script to reveal said decorated space.

18. Computer apparatus for forming a graphical representation from a template having a plurality of graphical objects arranged in a predetermined number of rendering layers spanning a geometric space, said apparatus comprising:
means for accessing at least one user-manipulable effect definition associated with one of said rendering layers, said effect definition including parameter information defining characteristics of said one layer;
means for modifying the parameter information of said effect definition to thereby incorporate a multiply instantiated user-definable graphical object distributed across said one layer according to a plurality of presentation rules;
means for generating a script of a graphical design formed by said layers;
means for rendering the script into a viewing memory image; and
means for outputting the memory image to a display device to thereby reproduce said graphical representation.
